(19) United States
(12) Patent Application Publication
(10) Pub. No.: US 2005/0229769 A1
(43) Pub. Date: Oct. 20, 2005

(54) System and method for assigning visual markers to the output of a filter bank

(76) Inventor: Nathaniel Resnikoff, Brookline, MA (US)

Correspondence Address: J. SCOTT SOUTHWORTH ATTORNEY AT LAW, P.O. BOX 1287, FRAMINGHAM, MA, 01701, US

(21) Appl. No.: 11/096,506

(22) Filed: Apr. 1, 2005

Related U.S. Application Data
(60) Provisional application No. 60/559,558, filed on Apr. 5, 2004.

(51) Int. Cl. G09B 15/00

(52) U.S. Cl. 84/483.2; 84/483.1

(57) ABSTRACT

A system and method for assigning visual markers to the output of a filter bank to establish a visual correspondence between octave equivalent outputs. The system includes an analyzer module and a graphic processing module. The analyzer module receives filter outputs from the filter bank, which has received as input a wave signal spanning multiple octaves. The graphic processing module generates a graphic image including displays of the filter outputs. The analyzer module assigns display sets to the filter outputs, assigns octave equivalence classes to display sets, and assigns visual markers to octave equivalence classes. The graphic processing module generates the displays of the filter outputs in the graphic image based on the assigned visual markers, the assigned octave equivalence classes, and the assigned display sets.

### RELATED APPLICATION

This application claims the benefit of U.S. Provisional Patent Application No. 60/559,558, filed on Apr. 5, 2004, the entire teachings of which are incorporated herein by reference.

### BACKGROUND

The term “filter bank analysis” is a general term for a process that provides information about the frequency content of a wave signal. A bank of filters can be created using physical means, such as electrical components with specific band-pass properties. The human ear is also a physical filter bank. Filter bank analysis can be accomplished computationally on a digital signal; the Fast Fourier transform (FFT) is an example of a digital filter bank. If the signal is acoustic, typical filter bank output has a meaning which can be interpreted, such as providing a musical interpretation. Typically, filter bank output is not presented in a manner that readily invites such usage.

### SUMMARY OF THE INVENTION

The present invention relates to the field of filter bank signal analysis, perception of audio information, and visual display of filter bank output. By coordinating filter bank output with its musical interpretation, in one embodiment, it is possible to attach the rich vocabulary of music to signals in general, and vice versa. Doing so allows the analytic realms of both signal processing and music analysis to access the strengths and insights of the other.

One purpose of the present invention is to teach a method by which the output of a filter bank based on an audio signal can be represented with many of its important musical qualities readily apparent. Another purpose of the present invention is to provide for the assignment of distinct visual markers (e.g., colors) to individual tones within an octave, which can be displayed simultaneously. A further purpose of the present invention provides for the assignment of visual markers (e.g., colors) to pitches and sounds (e.g., nonmusical audio input, such as noise produced by machinery) that may not be associated with a note of the chromatic scale.

In one aspect, the invention features a system for marking output of a filter bank. The filter bank includes multiple filters that provide filter outputs. The system includes an analyzer module and a graphic processing module. The analyzer module receives filter outputs from the filter bank based on an input to the filter bank. The input includes a wave signal spanning multiple octaves. The graphic processing module generates a graphic image that includes displays of the filter outputs. The analyzer module assigns display sets to the filter outputs in the filter bank, assigns one of a plurality of octave equivalence classes to each display set, and assigns one of a plurality of visual markers to each octave equivalence class. Each display set includes one or more filter outputs. The graphic processing module generates the displays of the filter outputs based on the assigned visual markers, and provides that each display of each filter output is based on the octave equivalence class of the display set for each filter output.

In one embodiment, the analyzer module assigns one or more visual markers to each octave equivalence class. In another embodiment, the visual markers are hues. The input to the filter bank, in other embodiments, is an audio signal. In another embodiment, the filter bank is a digital filter bank.

In another aspect, the invention features a system for marking output of a filter bank. The filter bank includes multiple filters that provide filter outputs. The system includes means for receiving filter outputs from the filter bank based on an input to the filter bank; means for assigning display sets to the filter outputs in the filter bank; means for assigning one of a plurality of octave equivalence classes to each display set; means for assigning one of a plurality of visual markers to each octave equivalence class; and means for generating the graphic image of the filter outputs based on the assigned visual markers to provide that each display of each filter output is based on the octave equivalence class of the display set for each filter output. The input includes a wave signal spanning multiple octaves. Each display set includes one or more filter outputs to display in the graphic image.

In one embodiment, the means for assigning one of a plurality of visual markers assigns one or more visual markers to each octave equivalence class. In another embodiment, the visual markers are hues. The input to the filter bank, in other embodiments, is an audio signal. In another embodiment, the filter bank is a digital filter bank.

In another aspect, the invention features a method for marking output of a filter bank including multiple filters. The method includes receiving filter outputs from the filter bank based on an input to the filter bank; assigning display sets to the filter outputs in the filter bank; assigning one of a plurality of octave equivalence classes to each display set; assigning one of a plurality of visual markers to each octave equivalence class; and generating the graphic image of the filter outputs based on the assigned visual markers to provide that each display of each filter output is based on the octave equivalence class of the display set for each filter output. The input includes a wave signal spanning multiple octaves. Each display set includes one or more filter outputs to display in the graphic image.

In one embodiment, the method includes assigning one or more of the visual markers to each octave equivalence class. In another embodiment, the visual markers are hues. The input to the filter bank, in other embodiments, is an audio signal. In another embodiment, the filter bank is a digital filter bank.

In another aspect, the invention features a computer program product that includes a computer readable medium having instructions stored thereon for a visual marker application for marking output of a filter bank including multiple filters. The instructions, when carried out by a processor of a computer, cause the computer to perform the steps of receiving filter outputs from the filter bank based on an input to the filter bank; assigning display sets to the filter outputs in the filter bank; assigning one of a plurality of octave equivalence classes to each display set; assigning one of a plurality of visual markers to each octave equivalence class; and generating the graphic image of the filter outputs based on the assigned visual markers to provide that each display of each filter output is based on the octave equivalence class of the display set for each filter output. The input includes a wave signal spanning multiple octaves. Each display set includes one or more filter outputs to display in the graphic image.

In another aspect, the invention features a computer program propagated signal product embodied in a propagated medium, having instructions for a visual marker application for marking output of a filter bank including multiple filters. The instructions, when carried out by a processor of a computer, cause the computer to perform the steps of receiving filter outputs from the filter bank based on an input to the filter bank; assigning display sets to the filter outputs in the filter bank; assigning one of a plurality of octave equivalence classes to each display set; assigning one of a plurality of visual markers to each octave equivalence class; and generating the graphic image of the filter outputs based on the assigned visual markers to provide that each display of each filter output is based on the octave equivalence class of the display set for each filter output. The input includes a wave signal spanning multiple octaves. Each display set includes one or more filter outputs to display in the graphic image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a digital display system in accordance with the principles of the invention.

FIG. 2 is a schematic drawing of the human hearing system.

FIG. 3 is an illustration of the components of sheet music.

FIG. 4 is a schematic drawing of the human vision system.

FIG. 5 is a flowchart of a filter bank analysis procedure in accordance with the principles of the invention.

FIG. 6 is a flowchart of a display generation procedure in accordance with the principles of the invention.

FIG. 7 is a grayscale birdcall image, rendering in grayscale a portion of a yodel of the common loon, with no assignment of visual markers.

FIG. 8 is a color birdcall image, rendering in color the yodel of FIG. 7 in accordance with the principles of the invention.

FIG. 9 is a grayscale excerpt image based on an excerpt of a musical composition, with no assignment of visual markers.

FIG. 10 is a color excerpt image rendering in color the excerpt of FIG. 9 in accordance with the principles of the invention.

FIG. 11 is a color conclusion image, based on the conclusion of a musical composition in accordance with the principles of the invention.

FIG. 12 is a musical composition image that shows a noncontinuous assignment of colors as visual markers for a short musical composition according to the principles of the invention.

### DETAILED DESCRIPTION

In overview, the invention relates to a system and method for improving the readability of filter bank output that takes advantage of the well-known property of human hearing that octave-equivalent pitches are closely identified. By representing signals with visual markers according to the principles of the invention, the information is easier to understand. Also, in the specific case where the audio signal is music, the encoding enables easy recognition of musical features; for example, chords and measures can be readily identified. One preferred embodiment provides for the visual marking of output with hue, but other markers can be used, such as texture or symbols drawn from some fixed inventory or library.

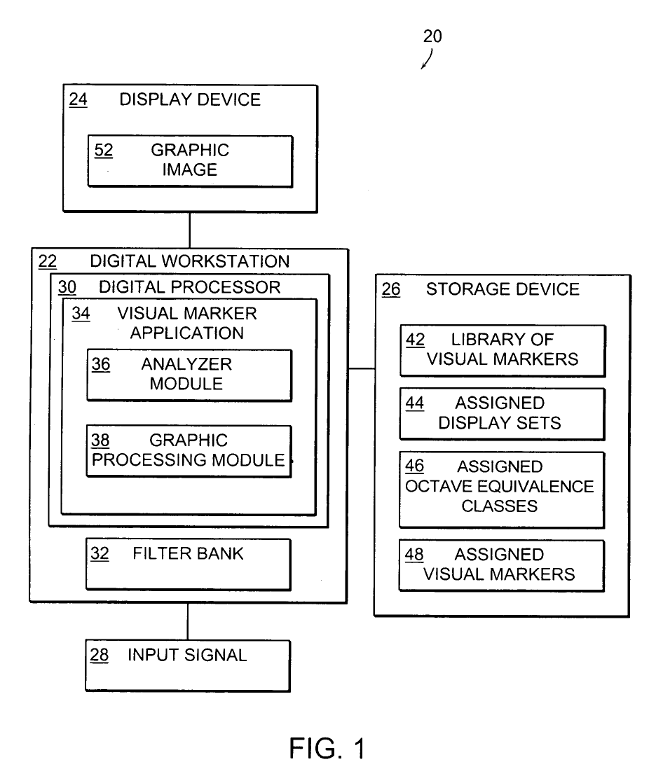

FIG. 1 is a block diagram of a digital display system 20 in accordance with the principles of the invention. The digital display system 20 includes a digital workstation 22, a display device 24, and a storage device 26.

The digital workstation 22 is a digital computing device, such as workstation, desktop PC computer, laptop computer or other suitable digital computing device, capable of receiving and processing an input signal 28 and displaying a graphic image 52 based on the input signal 28. The digital workstation 22 includes a digital processor 30, for example one or more digital integrated circuit (IC) microprocessors optionally including related IC circuitry and/or chips such as cache memory. The input signal 28 is a wave based signal. In a preferred embodiment, the input signal 28 is an audio input signal, or an analog electronic signal based on an audio input signal. For example, the input signal 28 is an analog electronic signal which is output from a microphone, which receives the source audio input as an airborne sound wave. Alternatively, the input signal 28 is a digital signal representing a wave, such as representing an audio wave. In another embodiment, the digital workstation 22 receives the input signal 28 from a network or suitable media, such as an audio tape or an audio CD.

The input signal 28 represents any suitable wave based signal suitable for analysis by a filter bank 32, which is a group of filters that provide information about the frequency content of the waveform signal. The filter bank 32 can use various approaches to analyzing the input signal 28, such as a Fourier transform (e.g., Fast Fourier Transform or FFT) or a wavelet approach. The audio input signal 28, for example, can be a musical input, bird call, whale song, machinery sound, or other suitable sonic input, and the filter bank 32 provides separate filter outputs for different frequencies included in the input signal 28. In other embodiments, the input signal 28 can be based on various wave signals, including electromagnetic waves, such as radio waves used in radio astronomy.

The storage device 26 includes media suitable for the storage of digital information, such as one or more of a hard disk, memory (e.g., random access memory or RAM), or other suitable storage medium. The storage device 26 includes a library of visual markers 42, assigned display sets 44, assigned octave equivalence classes 46, and assigned visual markers 48. The library of visual markers 42 is a digital library or database of visual markers suitable for marking the graphic image 52, which is based on the input signal 28. Such visual markers 42 can include hues, textures, icons, or other markers suitable for marking different aspects of the displayed graphic image 52. The assigned visual markers 48 are those markers that have been selected and assigned to mark some aspect of the graphic image 52. In a preferred embodiment, the assigned visual markers 48 are assigned to octave equivalence classes 46 to provide a visual correspondence between parts of the graphic image 52 that are considered octave equivalent. The assigned display sets 44 are sets or groups of filter outputs from the filter bank 32 that are combined for the purposes of display in the graphic image 52 (to be discussed in more detail later). In a preferred embodiment, each display set 44 is assigned an octave equivalence class 46.

The digital processor 30 executes the instructions of the visual marker application 34 to perform the functions of the invention as described herein. The instructions are stored in a volatile memory (e.g., RAM) or nonvolatile memory (e.g., hard disk or read only memory (ROM)) accessed by the digital processor 30. The visual marker application 34 include an analyzer module 36, which analyzes the filter outputs and is used by a human user through input/output devices to assign the display sets 44, octave equivalence classes 46, and visual markers 48. The visual marker application 34 also includes a graphic processing module 38 which processes filter outputs from the filter bank to generate a graphic image 52 based on the assigned display sets 44, assigned octave equivalence classes 46, and assigned visual markers 48, which are accessed from the storage device 26. The visual marker application 34 is implemented in the C++ programming language. In other embodiments, the visual marker application 34 is implemented in one or more other suitable computer programming languages.

The digital workstation 22 includes input/output devices, including, but not limited to, a display device 24 and one or more input communications ports for receiving one or more input signals 28. The display device 24 is an electronic device capable of displaying a digital graphic image 52. For example, the display device 24 is a cathode ray tube (CRT), or IC based display device such as a color LCD (liquid crystal display) device. Alternatively, the graphic image 52 can be saved in digital storage, such as storage device 26, for later display or sent over a network for display remotely.

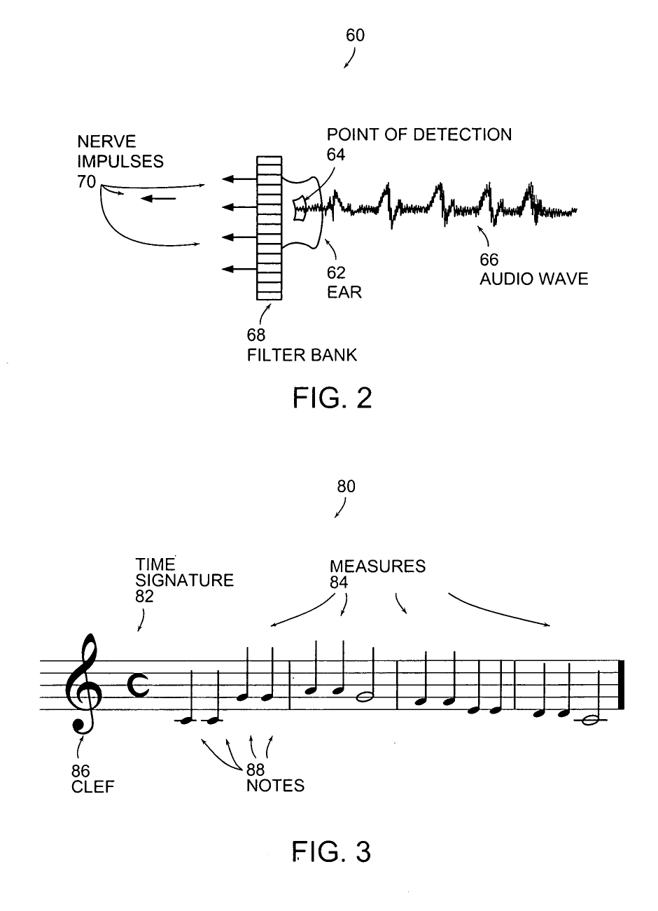

The digital display system 20 described for FIG. 1 presents a preferred embodiment of a hardware and software system of the invention. The next set of figures (FIGS. 2, 3, and 4) turn to a description of aspects of the human hearing system, components of sheet music, and the human vision system.

FIG. 2 is a schematic drawing of the human hearing system 60, including the ear 62, the point of detection 64 of an audio wave 66, a biological audio filter bank 68, and nerve impulses 70 that transmit the outputs of the biological audio filter bank 68 to the brain. Audible sound is the perceived sensation when variations in air pressure are sensed by the ear 62. The physical sound signal 66 can be represented as a time varying function that measures sound pressure at a fixed point, typically at a point of detection 64 at the ear drum. The normal ear 62 can detect sound waves 66 whose physical frequency of vibration varies between about 20 Hz and 20,000 Hz. The sensory apparatus of the ear 62 acts like a filter bank, each of whose component filters has a comparatively narrow frequency response compared with frequency range of audible sound. Each filter selects the signal energy in a limited range of frequencies. This range of frequencies, the “bandwidth” of the filter, generally increases as the frequencies increase. The output of each filter roughly represents the time-varying magnitude of the energy of the signal in the frequency band corresponding to the filter. Thus the ear 62, as a sensory system, provides a rough short-time Fourier transform magnitude analysis of the sound 66. The output of each filter is transmitted as neural impulses 70 to the brain for cognitive interpretation.

The ear 62 is capable of discriminating hundreds of distinct pitches. Normally, the listener has two ears 62 capable of simultaneously sensing the sound signal 66. Thus the normal sense of hearing samples a complex time varying physical sound at two places, and several hundred frequency bands at each place.

The perceived properties of sound signals are derived from the signal's physical properties, but they are not equivalent to the physical signal 66. The original sound waveform 66 cannot be reconstructed from the perceived data.

The study of music has developed a rich vocabulary to describe perceptual categories of sound. The lexicon includes basic properties like volume and frequency as well as more nuanced aspects such as cadence, accent, melody, and timing. One perceptual property that relates to the herein disclosed invention is the tendency for two tones whose physical frequencies are in the ratio 2:1 to be perceived as similar. Musically, the tones are said to differ by an “octave,” due to their historical placement 8 notes apart in a certain scale. Tones whose frequencies differ by an integral number of octaves, i.e. whose frequency ratio is an integral power of 2, are also perceived as similar, and are musically referred to as “octave equivalent” (termed herein as “OE”).

Perceptually, all octaves are the same size, although the range of frequencies doubles with each succeeding octave. For example, one particular octave spans 440−220=220 Hz, while another spans 880−440=440 Hz. An octave is conventionally divided into a “chromatic” scale of 12 equally spaced pitches. For example, pianos have 12 keys per octave.

FIG. 3 is an illustration of the components of sheet music 80. Music is also a written language, with a complex and expressive alphabet. Such “sheet” music is typically a rough time-frequency graph of a portion of the audible spectrum, with time on the horizontal axis indicated by a “time signature” 82 and frequency on the vertical axis. “Measures” 84 of time are marked out horizontally on each line. The symbolic alphabet includes, for example, “clefs” 86 to specify a reference frequency, and “notes” 88 and “chords” to specify pitch collections of certain onset times, durations, and frequencies.

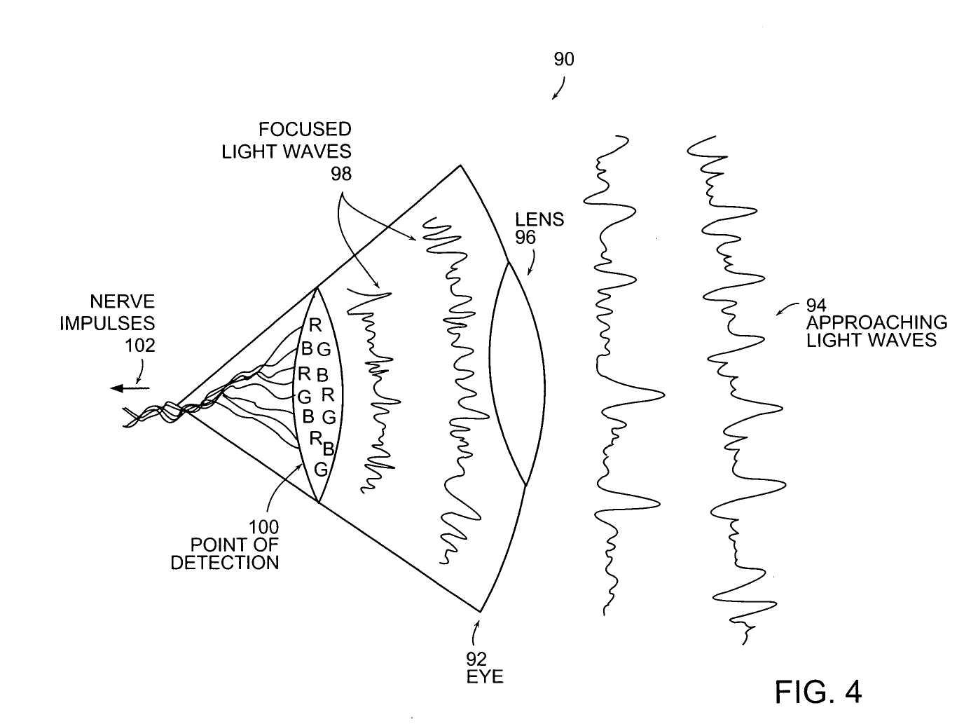

FIG. 4 is a schematic drawing of the human vision system 90, including the eye 92, approaching light waves 94, lens 96, focused light waves 98, visual point of detection 100 (retinal receptors), and nerve impulses 102. Vision is the perceived sensation when vibrations of the electromagnetic field, i.e. light, are sensed by the eye 92. The physical light signal can be represented as a time varying function that represents the vibrations of an electromagnetic field at a fixed point, typically at a point of detection 100 at a retinal receptor of the eye. The normal eye can detect light whose physical wavelength of vibration varies between about 400 nm and 700 nm. Color sensitive retinal receptors are arranged in the foveal region of the retina much like the red, blue and green light source elements of a color television CRT are arranged on the face of the CRT.

Like the ear 62, the eye 92 does not detect information sufficient to reconstruct the original wave 94. In particular, many different combinations of spectral distributions can result in the same perceived effect; i.e., color.

Three types of light sensitive receptors play the primary role in creating the perception of color. Each of these is a filter with a response that has a central peak at a characteristic frequency of light and tapers off to zero. The effective bandwidth of each receptor filter is comparatively large, and the response curves of the three filters overlap. Arranged in order of increasing peak frequency, the three filters are primarily, but not only, sensitive to physical light frequencies that are perceived as red, green and blue hues respectively. The output of these three filters is collectively responsible for the perception that is called “color.”

The retinal receptors of color vision are densely packed in the fovea, and the motion of the eye 92 scans the fovea over a comparatively large solid angle of visible space. Normally, the viewer has two eyes 92 capable of simultaneously sensing the light signal. Thus the vision system 90 is capable of acquiring vastly more spatial information than the auditory system 60 regarding the wave front 94 it is detecting. However, at each spatial position only the red, green and blue filters are available to provide frequency information about the light signal 94.

Sound signals 66 and light signals 94 are perceived with different processing models. For example, if two audible tones are played simultaneously, both are perceived. However, when two lights are combined, each of a single physical frequency, the result is perceived as a third color, distinct from the colors of the original two. In fact, infinitely many different pairs can produce the same perceived color. Such mixing of spectral hues can produce colors that do not appear in the visible light spectrum, i.e., do not correspond to a single frequency of light. In general, purples are mixtures of low- and high-frequency (red and blue) light; for example, magenta is a specific example of a non-spectral color (not in the visible light spectrum). One purpose of the present invention is to make use of the full variety of hues (including those not in the visible light spectrum) in representing sound.

All colors can be specified by three numbers. These numbers can be regarded as the frequencies of two distinct spectral colors and the proportion of mixture, but there are other, equivalent, ways of specifying the final resulting color, such as the RGB (red, green, blue) system used by CRTs and flat panel displays, and the HSB system, in which colors are specified by hue, saturation, and brightness.

One purpose of the present invention is to teach a method of visually representing filter-bank 32 output of input audio signals 28 in a way that takes advantage of the similarities in the otherwise rather different auditory 60 and visual perceptual systems 90. The following provides more details on aspects of the invention.

If two frequencies f₁ and f₂ are octave equivalent (OE), then
f₁=(2^{k})*f₂
where k is an integer. Using the notation:
   {x}=fractional part of x
the following can be written:
   {log₂(f₁)}={log₂(f₂)}
if and only if f₁ and f₂ are OE. This is the strict musical definition for OE tones. In practice, musical tones rarely consist of single, pure frequencies. A pair of tones is considered musically OE if they are close to being strictly OE and do not sound out of tune.

In general, two filters are OE if their central frequencies are OE. As with music, it is desirable to establish a looser definition of octave equivalence to accommodate practical considerations. If two filter bands have bandwidth comparable to a semitone, or smaller, and a large percentage of frequencies spanned by one are strictly OE to frequencies spanned by the other, then those filters are OE.

Representing an audio signal 66 as the output of a filter bank 32 is desirable because it corresponds closely to the human perception of sound. Filter bank output can be displayed in a spectral graph (also called a spectrogram, or sonogram). At a given XY coordinate, the magnitude of the filter response can be represented as a color chosen from a predefined color gradient. Common gradients include grayscale, “hot” and “cold” colors, or a red-to-blue axis.

“Bandwidth” is a well-known characteristic measure of the frequency response of a filter. A frequency range in music is referred to as an “interval,” which is measured in “cents” (100 cents=1 semitone; 1200 cents=1 octave). Note that intervals in cents are proportional to bandwidth measured in Hertz divided by the central frequency of the band in question.

If the frequency axis in a spectral graph is logarithmic, then the frequency distribution on the axis corresponds to the way it is perceived; that is, each octave occupies an equal visual range. In spectral graphs, position on the frequency axis is generally taken as an indication of octave equivalence class. However, small differences in spatial display can disguise large differences in musical function. For example, the spatial separation of 1200 cents for an octave is close to that of two pitches separated by 1100 cents (a major seventh), although the first one is a musical consonance and the second one is a musical dissonance. This musical distinction characterizes the perceptual difference that humans hear even with non-musical acoustic signals 66.

In some applications of the invention, the display of filter bank output may not correspond exactly to the form of the output itself. For example, successive filter outputs of a FFT have a constant frequency difference, so the bandwidth when measured in cents decreases steadily as the central frequency rises. In this case it may be desirable to combine the results of several adjacent filters with narrow bandwidth into a single wider display, such as a display set, that presents constant perceived difference.

In other cases, a filter bank 32 employs filters with overlapping responses whose outputs are combined for display, such as in a display set. In such cases, it is the octave equivalence of the display elements that is the subject of the invention.

Conventional spectral graphs make use of color to convey filter response magnitude only. For example, white may represent a high response, gray a low one, and black represents zero response. This use of color does not take full advantage of the medium. For example, if colors are represented by values of hue, saturation, and brightness, any of the three components can be used to convey magnitude, leaving the other two components unused. In particular, saturation and brightness are well-suited to the representation of non-periodic data, because they naturally vary on an interval. In one representation, hue varies on a circle, and is well-suited to representing periodic properties.

In a preferred embodiment of the present invention, the octave is mapped to a color circle, so that hue conveys octave equivalence class. In this embodiment, filter outputs are assigned a hue from the color circle, using a formula such as:
hue=2*PI*{log₂(f)}
where hue is identified with an angle on the conventional color circle, and f is the central frequency of the filter.

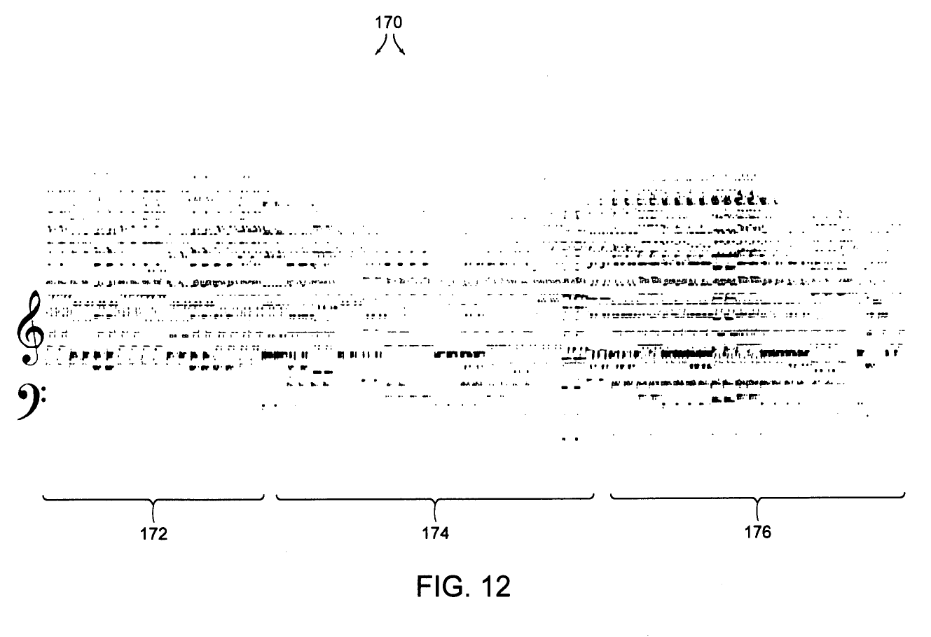

Because hue on the color circle varies smoothly, filter outputs with nearby hues are marked as belonging to nearby octave equivalence classes. In other embodiments, visual markers 42 are assigned using a relationship that does not vary continuously (see FIG. 12 and the related discussion).

In other embodiments, filter outputs are assigned a color from a color system representing the full range of perceived colors, based on mapping a range of outputs (e.g., frequencies) to the color system. In one embodiment, the octave is mapped to a range of values in a color system, such as an RGB or HSB color system. Thus, using the techniques of mapping to a color circle or a color system as described herein, the approach of the invention enables the use of the full variety of colors (including those not in the visible light spectrum).

If brightness is used to convey magnitude information, saturation remains unused. In the preferred embodiment of this invention, saturation is used to represent the bandwidth of the filter. For example, filters spanning more than 150 cents of bandwidth do not clearly specify a useful octave equivalence class, so assigning hue based on the central frequency alone is misleading. By decreasing saturation to zero as the bandwidth approaches this limit, the hue becomes “washed out.” Similarly, filters spanning less than 80 cents have a fully specified octave equivalence class, so saturation is increased to its maximum as that limit is approached. If saturation takes values between zero and one and a linear ramp is used, this relationship can be expressed as:
sat=max(0, min(1,(150−w)/(150−80)))
where sat is the desired saturation level, and w is a bandwidth expressed in cents.

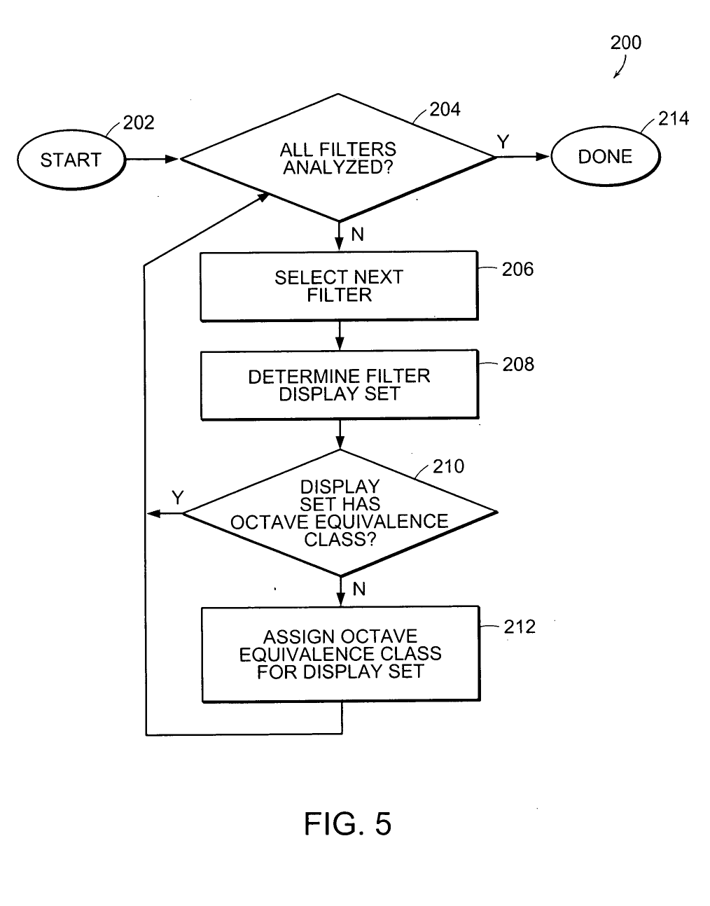

FIG. 5 is a flowchart of a filter bank analysis procedure 200 in accordance with the principles of the invention. From the start (step 202), the procedure 200 asks if all filters in the filter bank 32 have been analyzed (step 204). Each filter must be analyzed to determine which filter display set 44 that filter will be assigned to. If all have not been analyzed, then the procedure 200 selects the next filter in the filter bank 32 (step 206). The next step is to determine (i.e., assign) the filter to a display set 44. For example, if two filters output frequencies that are close in value (significantly less than a semitone apart, as discussed earlier) then those two filters can be assigned to the same display set 44. In one embodiment, a user examines the filter output values at the display device 24 for the digital workstation 22 using a user interface controlled by the analyzer module 36, and assigns each filter to a display set 44 based on the filter output values. In other embodiments, part or all of the analysis is done by the software, and some or all of the assignments are done by the software using various techniques. Such techniques include applying machine learning techniques, such as expert systems, neural net programs, and other suitable approaches, and/or include accessing a database of predetermined assignments.

The procedure 200 then asks if the display set 44 has an octave equivalent class 46 (step 210). If the answer is yes, the procedure 200 returns to step 204. If the answer is no, the next step is to assign an octave equivalence class 46 for the display set 44 (step 212). For example, if the display set 44 includes a set of filter output frequencies that are centered on or very close to 440 Hz, the note A, then that display set 44 is assigned to an octave equivalence class for the note A. The approach of the invention is not restricted to conventional semitone notes, but an octave equivalence class can be established based on an arbitrary frequency and its octave equivalents. In one embodiment, a user examines the display set information at a display device 24 for the digital workstation 22 using the user interface controlled by the analyzer module 36, and assigns an octave equivalence class 46 to a display set 44 based on the display set information. In other embodiments, part or all of the assignments are done by the software, using various techniques. Such techniques include accessing a database of predetermined assignments, and/or applying machine learning techniques, such as expert systems, neural net programs, and other suitable approaches.

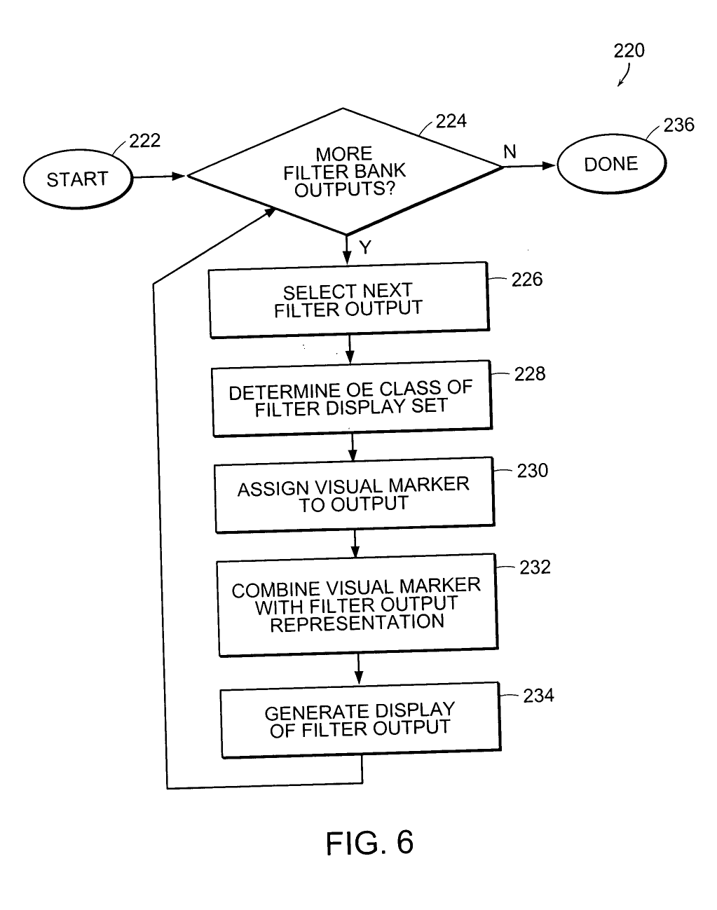

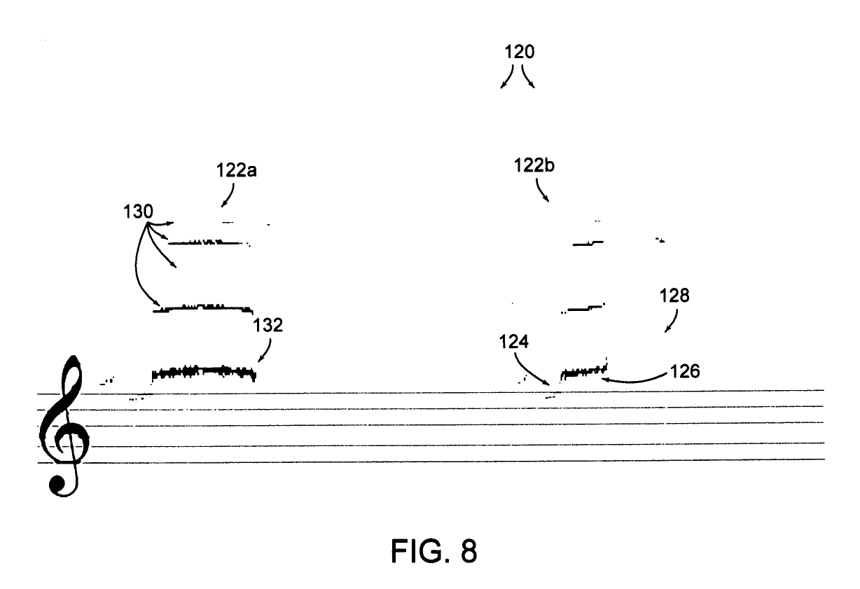

FIG. 6 is a flowchart of a display generation procedure 220 in accordance with the principles of the invention. From the start 222, the procedure 220 asks if there are any more filter bank outputs to display (step 224). If there is a filter that has not been displayed, then the next step is to select the next filter output from the filter bank 32 (step 226). The procedure then determines the octave equivalent class 46 of the display set 44 for the filter output (step 228) that was previously assigned in procedure 200. The next step is to assign one or more visual markers 42 to the filter output (step 230). In one embodiment, a user examines the information for the filter bank output and its octave equivalence class 46 at a display device 24 for the digital workstation 22 using the user interface controlled by the analyzer module 36, and assigns one or more visual markers 42 to the filter output information to provide for one or more assigned visual markers 48 for that filter output. The procedure 220 then combines the visual marker 48 with the filter output representation (step 232). For example, the graphic processing module 38 of the visual marker application 34 applies a color visual marker 48 assigned in step 230 to highlight the filter output with the color. The next step is to generate the display of the filter output in a graphic image 52 (step 234). For example, see the graphic images 52 displayed in FIGS. 8, 10, 11, and 12 and related discussions elsewhere herein.

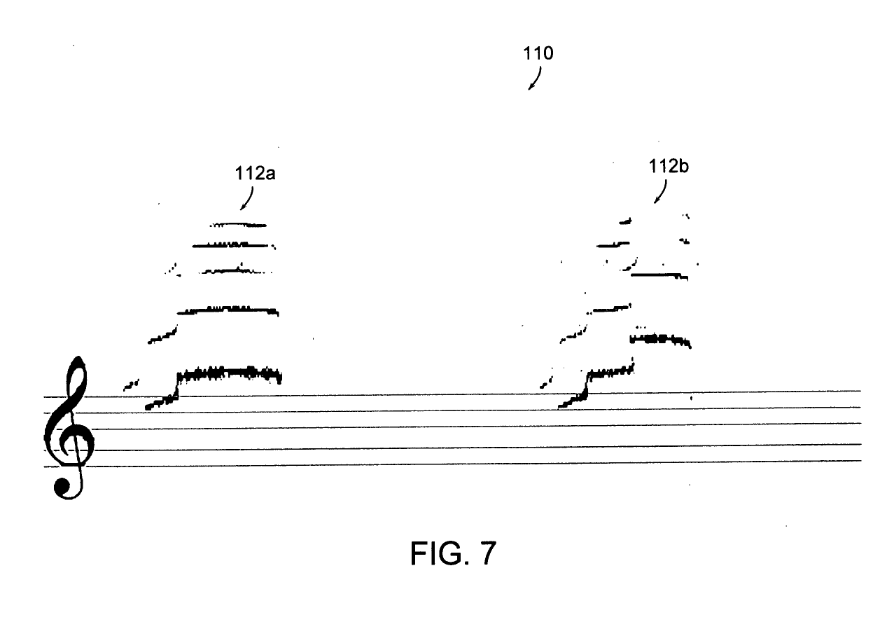

FIG. 7 is a grayscale birdcall image 110, rendering in grayscale a portion of a yodel of the common loon, with no assignment of visual markers 42. The illustration shows two segments 112a, and 112b (collectively referred to as “segments 112”) of the birdcall.

FIG. 8 is a color birdcall image 120, rendering in color the yodel of FIG. 7 in accordance with the principles of the invention. The illustration shows two segments 122a, and 122b (collectively referred to as “segments 122”) of the birdcall. Compared to FIG. 7, different notes in FIG. 8 are more readily apparent due to the use of color visual markers 48, such as those indicated by 124, 126, 128, 130, and 132. The octave equivalence of different notes is also more readily apparent than in FIG. 7, because in FIG. 8 the OE notes have the same color visual marker 48. Segment 122b includes an initial portion 124, an intermediate portion 126, and a final portion 128. It is now apparent for this segment 122b that the highest note, indicated by green in the final portion 128 is an octave of the lowest note, indicated by green in the initial portion 124. The green notes in the color birdcall image 120 represent one or more display sets 44 that have been assigned the same octave equivalence class 46 which has been assigned a visual marker 48 having a hue of green. Segment 122a includes overtones 130 of the note 132. It is readily apparent which of the overtones are octaves of the fundamental note 132, and the overtone pattern as a whole is more distinct.

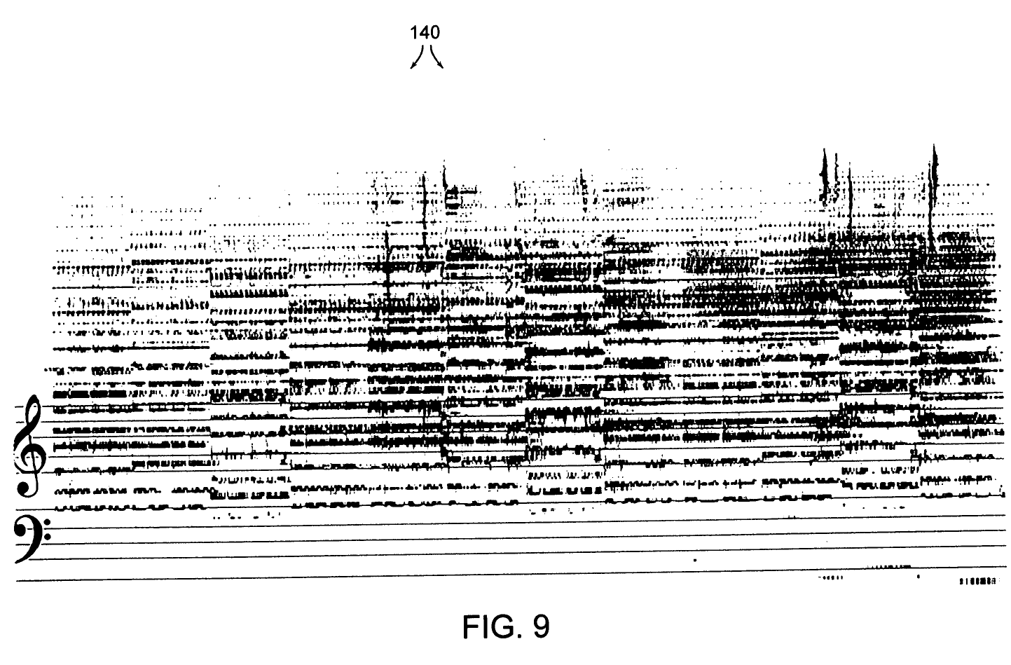

FIG. 9 is a grayscale excerpt image 140 based on an excerpt of a musical composition, with no assignment of visual markers.

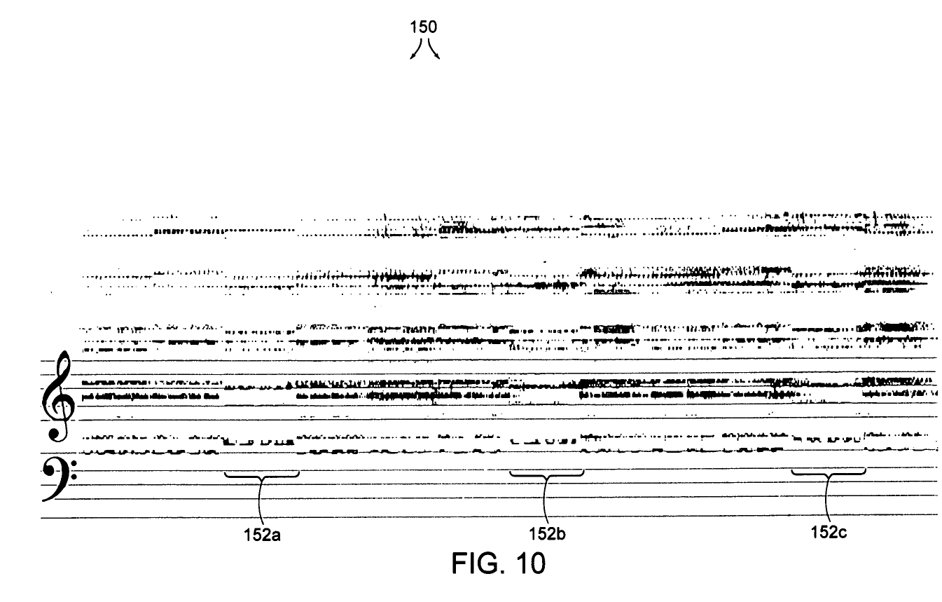

FIG. 10 is a color excerpt image 150, rendering in color the excerpt of FIG. 9 in accordance with the principles of the invention. The use of color makes it evident that chord portions 152a, 152b, and 152c (referred to collectively as “chord portions 152”) are the same chord (a G chord) displayed in different parts of the color excerpt image 150.

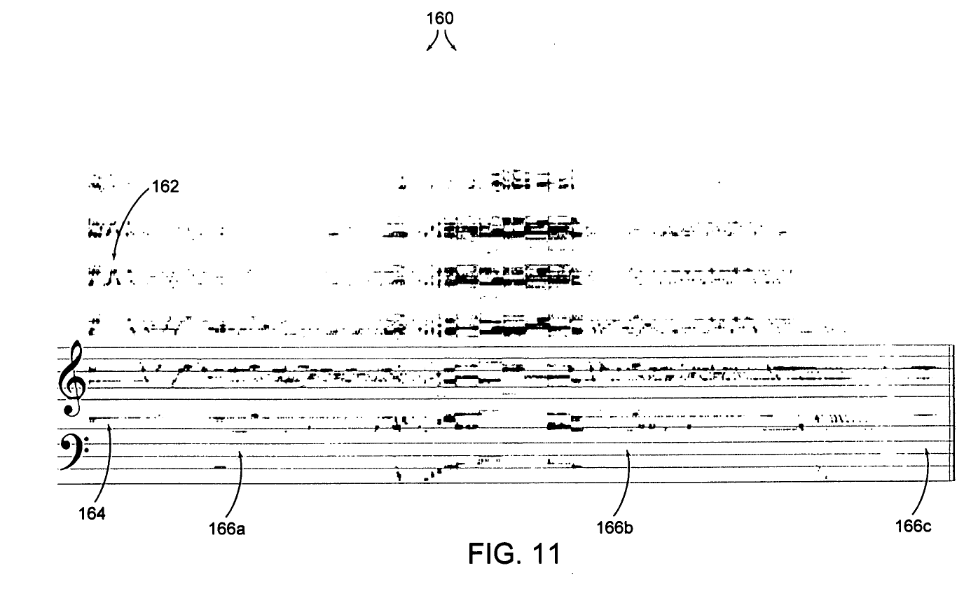

FIG. 11 is a color conclusion image 160 based on the conclusion of a musical composition in accordance with the principles of the invention. The color conclusion image 160 shows high note 162, base pedal tone 164, and notes 166a, 166b, and 166c (referred to collectively as “resolution notes 166”). In this embodiment, a hue of red corresponds to the note B and a hue of green to the note E. The high note 162 is a hue of orange, which makes apparent that it is not the same note as the bass pedal tone 164. Also, it can be seen from use of the color visual markers 48 that the bass pedal tone 164 is a dominant, resolving to the green note 166a. It is also apparent from the use of the color visual markers 48 that the resolutions at note 166b and note 166c are resolutions to tonic, as the color for note 166b and note 166c agree with the color for note 166a.

FIG. 12 is a musical composition image 170 that shows a noncontinuous assignment of colors as visual markers 48 for a short musical composition according to the principles of the invention. The 3-part segment includes a first part 172, a second part 174, and a third part 176.

In this embodiment of the invention, a noncontinuous mapping of visual markers 42 is used. Nearby notes are not assigned to nearby colors. The visual markers 48 for OE filter outputs are chosen to show their consonance with some given musical key or tone, given some preassigned set of consonance values relating the filters. As noted earlier, adjacent filters can have very different musical values, but such musical values are themselves OE. This embodiment assigns very different visual markers 48 to adjacent filters, rather than the smoothly varying changes in visual markers 48 from one filter output to the next adjacent filter output, which would be used in a continuous mapping.

FIG. 12 shows one example of a noncontinuous mapping. A green hue marks the tonic note, a red hue is the visual marker 48 for the dominant (Pythagorean ratio denominator=2); a yellow hue is the visual marker 48 for the predominants (denominator=3); and a blue hue is the visual marker 48 for other notes in the pentatonic scale (denominator=4, 5, or 8). Other tones in FIG. 12 are marked in grayscale.

The colors assigned as visual markers 48 in FIG. 12 permit the music theoretical observation that the musical composition falls into the three parts (172, 174, and 176). The first part 172 holds to tonic with small elaborations. The second part 174 returns to tonic after travels to harmonically distant lands. The third part 176 returns to tonic after a prolonged dominant. Thus, the use of visual markers 48 in FIG. 12 provides for the ready visual identification of different parts of a musical composition.

Turning from FIG. 12 and referring now to other embodiments, if two filters which are OE share any visual marker not shared by non-OE filters, then they are said to be visually marked as OE. The visual marker chosen to represent the equivalence classes need not be hue.

In another embodiment, markers 42 for octave equivalence will often be chosen with the property that they naturally vary on a circle. For example, if filter outputs are represented by icons chosen from some fixed inventory, the rotational orientation of the icon can be used to indicate octave equivalence class 46.

In other embodiments of the invention, OE filter outputs can be represented with specific sets of textures or patterns as display elements (e.g., visual markers 42). Each set of display elements has one visual property that is the same for all OE filters, and may have other visual properties, for example spatial placement, that represent other variables.

Filter output display need not be limited to the Cartesian grid in other embodiments. For example, filter output can be represented by a 3-dimensional perspective drawing, in which the filter outputs are represented as a surface. In another embodiment, the output is transformed by an arbitrary spatial mapping with the goal of increasing the aesthetic appeal of the imagery.

In other embodiments, the invention has utility in the analysis of both musical and non-musical acoustic data. The analysis of musical spectral data is significantly simplified by the ready association of tones in different octaves but the same octave equivalence class. Such tones occur in music as parts are doubled in multiple instruments, and as the most common form of overtone. Also, musical acoustic data benefits from access to the vocabulary of signal processing. For example, different kinds of drums can be discussed with reference to frequency response and bandwidth. The analysis of non-musical audio data benefits from being expressed in terms of the familiar vocabulary of music. Furthermore, octaves still retain their special qualities, and are emitted as overtones by many acoustic sound producers, such as machinery.

In one embodiment, the approach of the present invention can increase the functionality of a software application package designed for the visual manipulation of audio data, as the patterns of OE markers encode harmonic and melodic relationships. For example, spectral graphs of audio frequently contain notes whose vertical coordinate is well above the conventional musical staff. In music notation, such a tone would be represented using ledger lines, which are difficult to read. The presence of an OE marker (such as color) allows the note name of such a tone to be easily identified.

In other embodiments, a software application according to the principles of the invention can provide displays of input wave signals 28 for training, entertainment, astronomy (e.g., radio astronomy), digital audio editing and mixing, music composition, and/or other purposes. Such applications can include analysis of acoustic phenomena including speech analysis, acoustic evaluation and diagnosis of machinery, investigations of natural phenomena such as whale song or bird song, analysis of ambient noise or acoustic properties of architectural space, or human-assisted categorization of a collection of recordings. In other embodiments, such an application can provide entertainment in the form of a display coordinated with a music playback system, such as a home stereo, or a live performance sound mixer. In another embodiment, an application outputs a sonogram (e.g., in printed format) visually marked according to the principles of the invention, that can be included in a report, for example, on the mechanical status of an engine or other piece of machinery.

In one embodiment, a computer program product including a computer readable medium (e.g., one or more of DVD's, CD's, diskettes, tapes, and/or other suitable medium) provides software instructions for one or more of the modules 36, 38 of the visual marker application 34. The computer program product can be installed by any suitable software installation procedure, as is well known in the art. In another embodiment, a computer program propagated signal product embodied on a propagated signal on a propagation medium (e.g., a radio wave, an infrared wave, a sound wave, or an electrical signal propagated over the Internet or other network) provides software instructions for one or more of the modules 36, 38 of the visual marker application 34. Alternatively, the propagated signal is an analog carrier wave or a digital signal carried on the propagated medium. For example, the propagated signal can be a digitized signal propagated over the Internet or other network. In one embodiment, the propagated signal is a signal that is transmitted over the propagation medium over a period of time, such as the instruction for a software application sent in segments (e.g., packets) over a network over a period of seconds, minutes, or longer.

While the invention has been shown and described with reference to specific preferred embodiments, it should be understood by those skilled in the art that various changes in form and detail may be made therein without departing from the spirit and scope of the invention as defined by the following claims.

For example, the digital workstation 22 can be a small computer, a palmtop computer, or other electronic device such as a mobile telephone with a display screen suitable for displaying the displayed graphic image 52 according to the principles of the invention as described herein. If the assigned visual marker 48 is based on a hue, then the display screen of a small computer or mobile telephone is a color display screen. More generally, the digital workstation 22 can also be a hybrid device combining characteristics of a digital computer and a mobile telecommunications device.

In another example, the functions of the invention as described herein can be performed by two or more processors 30 distributed in different locations using a distributing computing (e.g., distributed object) approach through a network, the Internet, or other suitable connections. For example, one microprocessor 30 of one computer (e.g., client) can execute the instructions of the analyzer module 36 of the visual marker application 34 and another microprocessor 30 of a remote computer (e.g., server) can execute the instructions of the graphic processing module 38 of the visual marker application 34. Also, the data storage device 26 can be multiple storage devices that are accessible to the visual marker application 34.

1. A system for marking output of a filter bank, the filter bank comprising a plurality of filters providing a plurality of filter outputs, the system comprising:
an analyzer module that receives filter outputs from the filter bank based on an input to the filter bank, the input comprising a wave signal spanning a plurality of octaves; and
a graphic processing module that generates a graphic image comprising displays of the filter outputs,
wherein the analyzer module assigns display sets to the filter outputs in the filter bank, assigns one of a plurality of octave equivalence classes to each display set, and assigns one of a plurality of visual markers to each octave equivalence class, each display set comprising at least one filter output, and
wherein the graphic processing module generates the displays of the filter outputs based on the assigned visual markers, and provides that each display of each filter output is based on the octave equivalence class of the display set for each filter output.

2. The system of claim 1, wherein the analyzer module assigns at least one visual marker to each octave equivalence class.

3. The system of claim 1, wherein the visual markers are hues.

4. The system of claim 1, wherein the input to the filter bank is an audio signal.

5. The system of claim 1, wherein the filter bank is a digital filter bank.

6. A system for marking output of a filter bank, the filter bank comprising a plurality of filters providing a plurality of filter outputs, the system comprising:
means for receiving filter outputs from the filter bank based on an input to the filter bank, the input comprising a wave signal spanning a plurality of octaves;
means for assigning display sets to the filter outputs in the filter bank, each display set comprising at least one filter output to display in a graphic image;
means for assigning one of a plurality of octave equivalence classes to each display set;
means for assigning one of a plurality of visual markers to each octave equivalence class; and
means for generating the graphic image of the filter outputs based on the assigned visual markers to provide that each display of each filter output is based on the octave equivalence class of the display set for each filter output.

7. The system of claim 6, wherein the means for assigning one of a plurality of visual markers assigns at least one visual marker to each octave equivalence class.

8. The system of claim 6, wherein the visual markers are hues.

9. The system of claim 6, wherein the input to the filter bank is an audio signal.

10. The system of claim 6, wherein the filter bank is a digital filter bank.

11. A method for marking output of a filter bank comprising a plurality of filters, the method comprising:
receiving filter outputs from the filter bank based on an input to the filter bank, the input comprising a wave signal spanning a plurality of octaves;
assigning display sets to the filter outputs in the filter bank, each display set comprising at least one filter output to display in a graphic image;
assigning one of a plurality of octave equivalence classes to each display set;
assigning one of a plurality of visual markers to each octave equivalence class; and
generating the graphic image of the filter outputs based on the assigned visual markers to provide that each display of each filter output is based on the octave equivalence class of the display set for each filter output.

12. The method of claim 11, wherein assigning one of a plurality of visual markers comprises assigning at least one visual marker to each octave equivalence class.

13. The method of claim 11, wherein the visual markers are hues.

14. The method of claim 11, wherein the input to the filter bank is an audio signal.

15. The method of claim 11, wherein the filter bank is a digital filter bank.

16. A computer program product that comprises a computer readable medium having-instructions stored thereon for a visual marker application for marking output of a filter bank comprising a plurality of filters, such that the instructions, when carried out by a processor of a computer, cause the computer to perform the steps of:
receiving filter outputs from the filter bank based on an input to the filter bank, the input comprising a wave signal spanning a plurality of octaves;
assigning display sets to the filter outputs in the filter bank, each display set comprising at least one filter output to display in a graphic image;
assigning one of a plurality of octave equivalence classes to each display set;
assigning one of a plurality of visual markers to each octave equivalence class; and
generating the graphic image of the filter outputs based on the assigned visual markers to provide that each display of each filter output is based on the octave equivalence class of the display set for each filter output.

17. A computer program propagated signal product embodied in a propagated medium, having instructions for a visual marker application for marking output of a filter bank comprising a plurality of filters, such that the instructions, when carried out by a processor of a computer, cause the computer to perform the steps of:
receiving filter outputs from the filter bank based on an input to the filter bank, the input comprising a wave signal spanning a plurality of octaves;
assigning display sets to the filter outputs in the filter bank, each display set comprising at least one filter output to display in a graphic image;
assigning one of a plurality of octave equivalence classes to each display set;
assigning one of a plurality of visual markers to each octave equivalence class; and
generating the graphic image of the filter outputs based on the assigned visual markers to provide that each display of each filter output is based on the octave equivalence class of the display set for each filter output.
